(19) United States
(12) Patent Application Publication
(10) Pub. No.: US 2026/0030533 A1
(43) Pub. Date: Jan. 29, 2026

(54) METHODS AND APPARATUSES FOR STABILIZATION OF MOTIONAL MODES THROUGH STRAY ELECTRIC FIELD COMPENSATION

(71) Applicant: IonQ, Inc., College Park, MD (US)

(72) Inventors: Shantanu DEBNATH, Lanham, MD (US); Jason Hieu Van NGUYEN, Hyattsville, MD (US)

(21) Appl. No.: 18/663,872

(22) Filed: May 14, 2024

Related U.S. Application Data
(60) Provisional application No. 63/502,840, filed on May 17, 2023.

(51) Int. Cl. G06N 10/40; G21K 1/00

(52) U.S. Cl. CPC G06N 10/40; G21K 1/00

(57) ABSTRACT

Aspects of the present disclosure may include a method and/or a system for applying a plurality of electric fields to the ion chain, selecting a plurality of motional modes associated with the ion chain, identifying a plurality of frequency shifts each corresponding to a motional mode of the plurality of motional modes in response to each electric field of the plurality of electric fields, detecting one or more unintended frequency shifts caused by the stray electric field, identifying an orientation and an intensity of the stray electric field based on comparing the one or more unintended frequency shifts to at least a portion of the plurality of frequency shifts, and applying a compensating electric field based on the orientation and the intensity of the stray electric field.

### CROSS REFERENCE TO RELATED APPLICATIONS

The current application claims priority to, and the benefit of, U.S. Provisional Application No. 63/502,840 filed May 17, 2023 and entitled “METHODS AND APPARATUSES FOR STABILIZATION OF MOTIONAL MODES THROUGH STRAY ELECTRIC FIELD COMPENSATION,” the contents of which are hereby incorporated by reference in their entireties.

### BACKGROUND

A quantum information processing (QIP) system may utilize trapped ions as qubits to store the states of the computations for the QIP system to function accurately. The states of trapped ions may be sensitive to many environmental noises that may undesirably alter the states. For example, stray electric field caused by accumulated charges near the trapped ions may degrade the fidelity of the qubit states. Therefore, improvement may be desirable.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

Aspects of the present disclosure may include a method and/or a system for applying a plurality of electric fields to the ion chain, selecting a plurality of motional modes associated with the ion chain, identifying a plurality of frequency shifts each corresponding to a motional mode of the plurality of motional modes in response to each electric field of the plurality of electric fields, detecting one or more unintended frequency shifts caused by the stray electric field, identifying an orientation and an intensity of the stray electric field based on comparing the one or more unintended frequency shifts to at least a portion of the plurality of frequency shifts, and applying a compensating electric field based on the orientation and the intensity of the stray electric field.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The disclosed aspects will hereinafter be described in conjunction with the appended drawings, provided to illustrate and not to limit the disclosed aspects, wherein like designations denote like elements, and in which:

FIG. 1 illustrates an example of a configuration for compensating stray electric field according to aspects of the present disclosure.

FIGS. 2a-d illustrate examples of frequency shifts of the motional modes under the application of electric fields according to aspects of the present disclosure.

FIGS. 3a-d illustrate examples of frequency shifts of selected motional modes as a function of electric fields according to aspects of the present disclosure.

FIG. 4 illustrates an example of a QIP system according to aspects of the present disclosure.

FIG. 5 illustrated an example computer system or device in accordance with aspects of the disclosure.

FIG. 6 illustrates an example of a control system configured to control the ion chain according to aspects of the present disclosure.

FIG. 7 illustrates an example of a method for compensating stray electric field according to aspects of the present disclosure.

FIG. 8 illustrates a view of atomic ions a linear crystal or chain in accordance with aspects of this disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

In certain aspects, a two-qubit entangling quantum gate within a trapped ion quantum processor may be implemented using schemes where the internal qubit state of a qubit interacts with the vibrational motional modes of a chain of trapped ions (where each or a subset of ions constitute the multi-qubit processor). The vibrational modes of motion may be used as a quantum bus to transport the qubit information across a part of or the entire chain of ions, thereby enabling entanglement between any arbitrary pairs of qubits in the processor. For high fidelity entangling operations, it is therefore important to achieve a reasonably high degree of stability of the motional modes of the chain.

Factors that may affect the stability of motional modes include changes in the ion trap environment. For example, a chain of ions may be trapped using both static and oscillating electric fields. A linear chain of trapped ions may be an example of a multi-qubit trapped ion quantum processor. Such chains of ions may be trapped on a surface ion-trap using transverse (perpendicular to the chain) and axial (along the chain) electrical confinement by applying voltages to arrays of electrodes that generate the electric fields of the ion trap. However, there may be spurious excess fields in such a trap that can disturb the ion trapping potential and cause distortions in the chain arrangement. The spurious excess fields may be caused by a variety of factors, such as surface charge accumulation due to light exposure. Since a trapped-ion chain has strong Coulomb interaction among the ions, any small distortion or deviation of a chain arrangement may change the motional modes of vibrations of the chain enough to cause non-negligible errors in the entangling gate operation.

Aspects of the present disclosure include stabilizing the motional modes of an ion chain by measuring the variation of the motional mode spectrum as a function of applied excess stray electric fields. Stray electric fields may arise in all three directions of the ion-trap, henceforth denoted by E_{X}, E_{Y}, and E_{Z}, where the x-direction is along a linear chain of trapped ions, y-direction is perpendicular to the chain and parallel to the surface trap, and the z-direction is the direction perpendicular to the surface trap and the chain. The surface trap electrodes are in the x-y plane. Another aspect of the present disclosure includes compensating the E_{X1} field, which is the first derivative (or slope) of the E_{X} field along the chain length (x-direction). Mathematically, E_{X1}=dE_{X}/d_{X}.

In some instances, the lowest order stray electric fields are commonly generated in ion traps, and may have substantial contribution to motional mode distortion, and therefore, the gate fidelity. Therefore, it may be desirable to compensate the lowest order stray electric fields.

There are numerous advantages to the current scheme. First, the current scheme achieves motional mode stabilization since mode spectroscopy directly measures mode distortion as a function of stray electric field components, followed by the compensation scheme that eliminates mode spectrum distortion. Second, the accuracy of the current scheme may be increased on demand at the cost of increasing probing time of mode spectroscopy. Since the measured parameter is the frequency of the modes, the current scheme is resistant against drifts and fluctuations in the power of the laser used for spectroscopy, and also the thermal excitation of the motional mode. Third, the process may be accelerated by performing partial and fast spectroscopy of the mode spectrum, while obtaining the signals for compensating each stray electric field component.

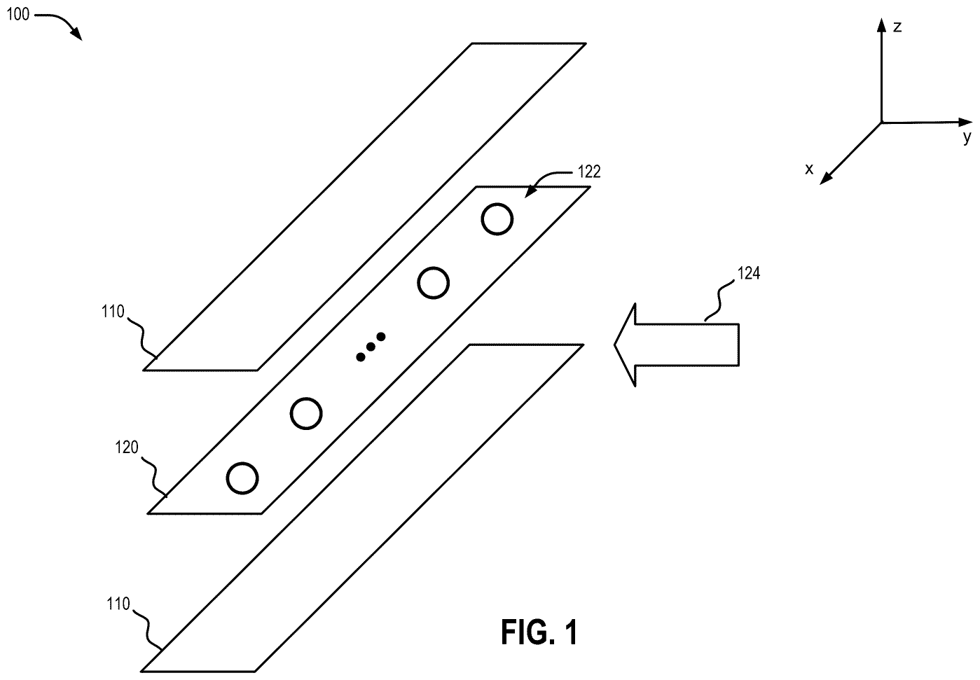

FIG. 1 illustrates an example of a configuration 100 for compensating for stray electric field according to aspects of the present disclosure. In some aspects, the configuration 100 may include one or more electrodes 110 configured to apply electric fields of various orientations. The one or more electrodes 110 may be configured to apply x-direction electric fields, y-direction electric fields, and/or z-direction electric fields.

In certain aspects, the configuration 100 may include a surface trap 120 configured to confine an ion chain 122. As shown in the exemplary aspect, the one or more electrodes 110 comprise a pair of planar electrodes disposed on opposite sides of the surface trap 120. The configuration 100 may include the ion chain 122 configured to be implemented in a quantum information processing (QIP) system (not shown). The ion chain 122 may be configured to perform quantum computation based on the interaction among the ions in the ion chain. The ion chain 122 may be illuminated with one or more light beams 124 from one or more directions. For example, the one or more light beams 124 may include a global beam and one or more individually addressing Raman beams.

In an aspect, the ions in the ion chain 122 may be mutually coupled. Specifically, the ions in the ion chain 122 may vibrate at a same frequency, whether in the x-, y-, and/or z-directions. The vibration of the ions may be in the same directions, the opposition directions, and/or different directions. As a result, the ions in the ion chain 122 may vibrate according one or more motional modes. The vibration frequencies of the motional modes may depend on the spacings between the ions of the ion chain 122, the presence of light and/or electric fields, and/or other factors.

In some instances, undesirable (e.g., unintended) stray electric fields may appear due to, for example, the generation of unwanted charges on the surface trap 120. The undesirable stray electric fields may cause shifts (in frequencies) in some or all of the motional modes. As a result, the shifts may degrade the fidelity of the quantum computation.

In additional aspects, the ion chain 122 may experience numerous electric fields. There may be electric fields applied to the ion chain to change the states of the ion chain during quantum computations. There may be undesirable/unintended stray field induced by the presence of unwanted charges (electrical charges that negatively impact the fidelity of the states of the trapped ions). The undesirable/unintended stray field may cause unintended frequency shifts of the trapped ions. There may be compensation field applied to the ion chain to compensate for the effects of the stray field. Here, the terms unintended stray fields or unintended frequency shifts mean electric fields or frequency shifts, respectively, caused by the presence of the unwanted charges. As indicated in the present application, the unintended stray fields are induced by the presence of unwatned charges and cause unintended frequency shifts that negatively impact the fidelity of the states of the trapped ions. Aspects of the present disclosure include schemes for mitigating or eliminating the impact of the unintended stray fields and/or the unintended frequency shifts.

Aspects of the present disclosure includes 1) applying electric fields to the ion chain 122, 2) measuring the changes in vibrational frequency to the one or more motional modes, 3) during computation using the ion chain 122, detecting any change to the vibrational frequency of the one or more motional modes caused by stray electric field, 4) identifying the stray electric field intensity and orientation based on the measurement and the change detected, and 5) applying a compensation field to counter the stray electric field.

In certain aspects, the one or more electrodes 110 may apply electric fields to the ion chain 122. In one example, the one or more electrodes 110 may apply an x-direction electric field (E_{X}) to the ion chain 122. As a result the frequency of the one or more motional modes may shift. The frequency shifts for the one or more motional modes may be measured as a function of E_{X} intensity.

In other aspects, the one or more electrodes 110 may apply a y-direction electric field (E_{X}) to the ion chain 122. As a result the frequency of the one or more motional modes may shift. The frequency shifts for the one or more motional modes may be measured as a function of E_{Y} intensity.

In yet another aspect, the one or more electrodes 110 may apply a z-direction electric field (E_{Z}) to the ion chain 122. As a result the frequency of the one or more motional modes may shift. The frequency shifts for the one or more motional modes may be measured as a function of E_{Z} intensity.

In some aspects, the frequency shifts for the one or more motional modes may be measured as a function of the change in E_{X}, E_{Y}, and/or E_{Z}. The measurements above may be performed without any stray electric field.

During operation, any frequency shift caused by stray electric field may be compared to the measurements of the frequency shifts caused by the application of the E_{X}, E_{Y}, and/or E_{Z} by the one or more electrodes 110. By identifying the frequency shift caused by the stray electric field, it is possible to identify the orientation, and/or the intensity of the stray electric field. Consequently, aspects of the present disclosure include applying a compensation field to compensate for the stray electric field.

Specifically, the compensation field may be applied to “cancel out” the stray electric field to perform compensation. The compensation field may be an electric field that has a field vector with the same amplitude as the stray electric field but points in the opposite direction. In other words, the compensation field may have the same field strength (as experienced by the ions of the ion chain 122) as the stray electric field and oppose the stray electric field. For example, a stray electric field having a field strength of n V/cm that orients in the [1, 1, 1] direction may be compensated by a compensation field having the same field strength (i.e., n V/cm) and orients in the [−1, −1, −1] direction.

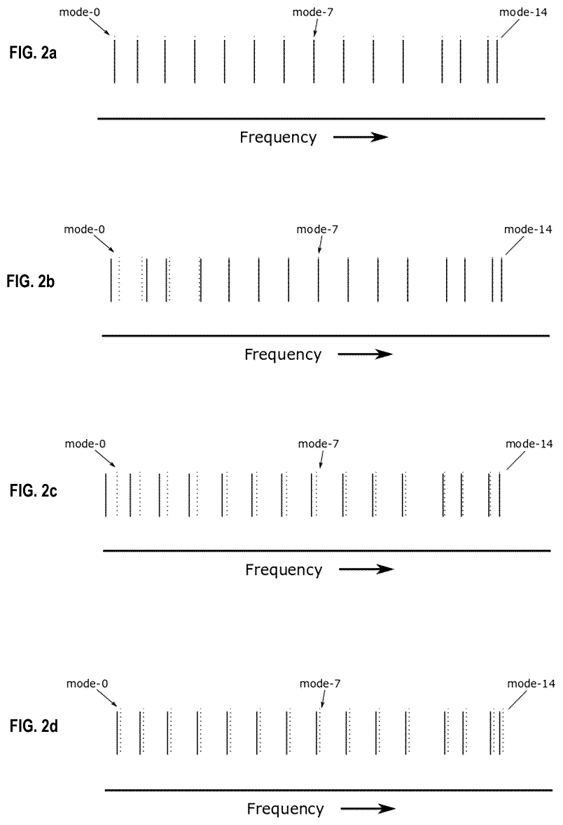

FIG. 2 illustrates an example of frequency shifts of motional modes during the application of electric fields. For example, the example in FIG. 2 may be associated with an ion chain having 15 ions trapped in an anharmonic potential on a surface ion trap. FIG. 2 illustrates the frequency spectrum of the transverse (y-direction) mode spectrum, which may be used in the entangling gates. There may be N modes corresponding to the number of ions in the ion chain. In FIG. 2, the ion with 15 ions may have 15 normal modes of motion along a given transverse direction, and each mode may have a distinct vibrational frequency. The solid lines represent the original unperturbed mode spectrum, and the dotted lines show the distorted spectrum in the presence of electric field (e.g., stray electric field).

In some aspects, FIG. 2(a) shows the effect of applied E_{Y} stray electric field. Here, the application of the E_{Y} field does not distort the motional mode spectrum.

FIG. 2(b) shows the mode spectrum distortion in the presence of an E_{X} field. Some “low” energy normal modes (e.g., mode-0) exhibit frequency deviations from the original frequency. The distortion in the “high” energy normal modes (e.g., mode-14) appears to be minimal. The mode spectrum distortion under an applied E_{X} field exhibits a low-energy-mode shift effect.

FIG. 2(c) shows the mode spectrum distortion during the application of an E_{X1} field. Here, the electric field changes as a function of distance along the x-direction (along the ion chain). The spectrum spreads out in frequency. The mode spectrum distortion under an applied E_{X1} field exhibits a mode-breathing effect.

FIG. 2(d) shows the mode spectrum distortion in the presence of an E_{Z} field. Here, the entire spectrum shifts in frequency. The mode spectrum distortion under an applied E_{Z} field exhibits a mode-spectrum-shift effect.

In some aspects of the present disclosure, for the compensation routine described above, it may be advantageous to measure a subset of the entire mode spectrum to perform spectroscopy. In other words, rather than measuring the frequency shifts of each mode under the application of electric fields, aspects of the present disclosure includes measuring a subset of the motional modes (e.g., 3 out of 15) to capture the behaviors shown in FIG. 2. As such, the speed of the compensation routine is increased due to less spectroscopy measurements.

An aspect of the present disclosure includes selecting the subset of motional modes for the spectroscopy measurement. The selection may be based on selecting motional modes that span the modal spectrum. The selection may be based on selecting motional modes relevant to quantum computing. The selection may be based on selecting motional modes that are known to exhibit more sensitivity to stray electric fields. For the example shown in FIG. 2, one aspect includes selecting the lowest mode (i.e., mode-0), the middle mode (i.e., mode-7), and the highest mode (i.e., mode-14) of the transverse modes for the measurement. In another aspect, one of the lower modes (e.g., one of the lowest 3 modes) may be selected, along with the middle mode and the highest mode.

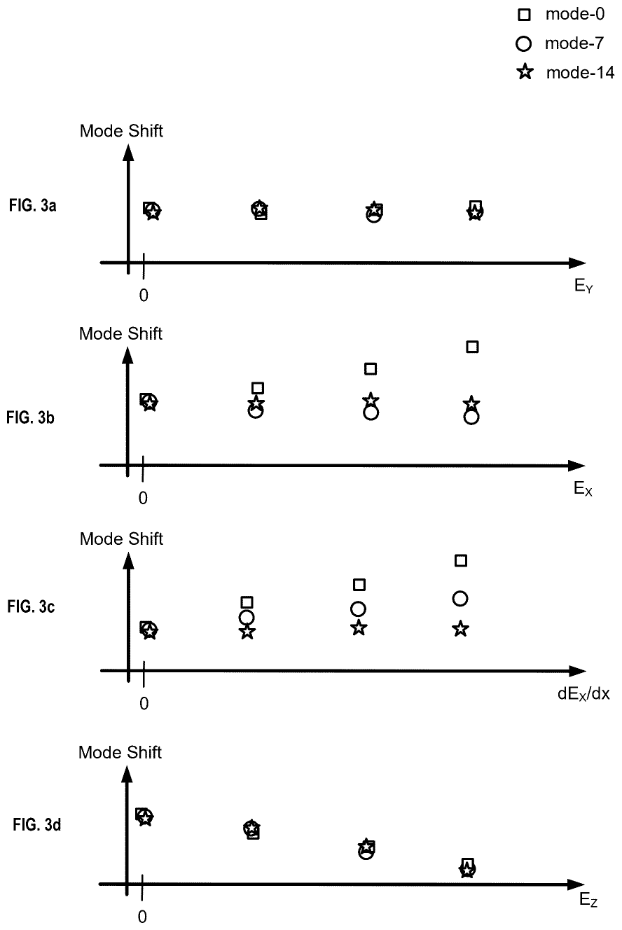

FIG. 3 illustrates examples of spectroscopy measurements according to aspects of the present disclosure. In the current example, the lowest mode (i.e., mode-0), the middle mode (i.e., mode-7), and the highest mode (i.e., mode-14) of the transverse modes are selected for the spectroscopy measurements when the ion chain is under the application of electric field as shown in FIG. 2. Other number of modes and/or the order of the modes may also be selected according to aspects of the present disclosure.

FIG. 3(a) corresponds to FIG. 2(a), which shows the sampled behavior of the motional modes of the ion chain under the application of the E_{Y} stray electric field. As indicated above, the E_{Y} stray electric field causes no frequency shifts of the motional modes. As such, FIG. 3(a) illustrates that the mode-0, mode-7, and mode-14 of the ion chain remain substantially constant with increasing E_{Y} stray electric field.

FIG. 3(b) corresponds to FIG. 2(b), which shows the sampled behavior of the motional modes of the ion chain under the application of the E_{X} stray electric field. As indicated above, the E_{X} stray electric field causes the low-energy-mode shift effect on the motional modes. As such, FIG. 3(b) illustrates that the mode-0 of the ion chain increases in frequency shift with increasing E_{X} stray electric field. The mode-7 of the ion chain decreases (but at a lower rate than mode-0) in frequency shift with increasing E_{X} stray electric field. The mode-14 of the ion chain remains substantially constant with increasing E_{X} stray electric field.

FIG. 3(c) corresponds to FIG. 2(c), which shows the sampled behavior of the motional modes of the ion chain under the application of the E_{X1} stray electric field. As indicated above, the E_{X1} stray electric field causes the mode-breathing effect on the motional modes. As such, FIG. 3(c) illustrates that the mode-0 of the ion chain increases in frequency shift with increasing E_{X1} stray electric field. The mode-7 of the ion chain increases (but at a lower rate than mode-0) in frequency shift with increasing E_{X1} stray electric field. The mode-14 of the ion chain remains substantially constant with increasing E_{X1} stray electric field.

FIG. 3(d) corresponds to FIG. 2(d), which shows the sampled behavior of the motional modes of the ion chain under the application of the E_{Z} stray electric field. As indicated above, the E_{Z} stray electric field causes the mode-spectrum shift effect on the motional modes. As such, FIG. 3(d) illustrates that the mode-0, mode-7, and the mode-14 of the ion chain increases (substantially uniformly at the same rate) in frequency shift with increasing E_{Z} stray electric field.

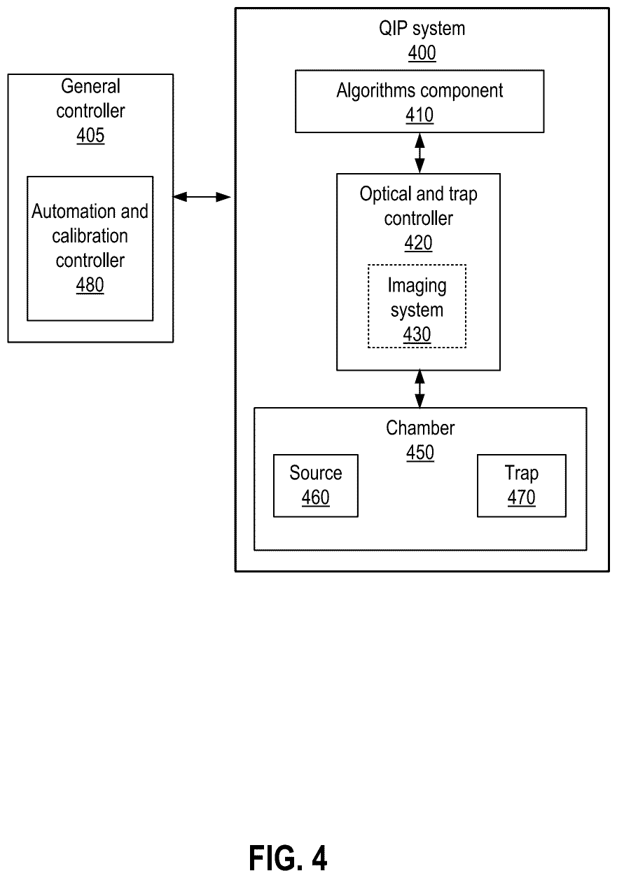

FIG. 4 shown below is a block diagram that illustrates an example of a QIP system 400 in accordance with various aspects of this disclosure.

The QIP system 400 may also be referred to as a quantum computing system, a quantum computer, a computer device, a trapped ion system, or the like. The QIP system 400 may be part of a hybrid computing system in which the QIP system 400 is used to perform quantum computations and operations and the hybrid computing system also includes a classical computer to perform classical computations and operations.

Shown in FIG. 4 is a general controller 405 configured to perform various control operations of the QIP system 400. Instructions for the control operations may be stored in memory (not shown) in the general controller 405 and may be updated over time through a communications interface (not shown). Although the general controller 405 is shown separate from the QIP system 400, the general controller 405 may be integrated with or be part of the QIP system 400. The general controller 405 may include an automation and calibration controller 480 configured to perform various calibration, testing, and automation operations associated with the QIP system 400.

The QIP system 400 may include an algorithms component 410 that may operate with other parts of the QIP system 400 to perform quantum algorithms or quantum operations, including a stack or sequence of combinations of single qubit operations and/or multi-qubit operations (e.g., two-qubit operations) as well as extended quantum computations. As such, the algorithms component 410 may provide instructions to various components of the QIP system 400 (e.g., to the optical and trap controller 420) to enable the implementation of the quantum algorithms or quantum operations. The algorithms component 410 may receive information resulting from the implementation of the quantum algorithms or quantum operations and may process the information and/or transfer the information to another component of the QIP system 400 or to another device for further processing.

The QIP system 400 may include an optical and trap controller 420 that controls various aspects of a trap 470 in a chamber 450, including the generation of signals to control the trap 470, and controls the operation of lasers and optical systems that provide optical beams that interact with the atoms or ions in the trap. When used to confine or trap ions, the trap 470 may be referred to as an ion trap. The trap 470, however, may also be used to trap neutral atoms, Rydberg atoms, different atomic ions or different species of atomic ions. The lasers and optical systems can be at least partially located in the optical and trap controller 420 and/or in the chamber 450. For example, optical systems within the chamber 450 may refer to optical components or optical assemblies.

The QIP system 400 may include an imaging system 430. The imaging system 430 may include a high-resolution imager (e.g., CCD camera) or other type of detection device (e.g., photomultiplier tube or PMT) for monitoring the atomic ions while they are being provided to the trap 470 and/or after they have been provided to the trap 470. In an aspect, the imaging system 430 can be implemented separate from the optical and trap controller 420, however, the use of fluorescence to detect, identify, and label atomic ions using image processing algorithms may need to be coordinated with the optical and trap controller 420.

In addition to the components described above, the QIP system 400 can include a source 460 that provides atomic species (e.g., a plume or flux of neutral atoms) to the chamber 450 having the trap 470. When atomic ions are the basis of the quantum operations, that trap 470 confines the atomic species once ionized (e.g., photoionized). The trap 470 may be part of a processor or processing portion of the QIP system 400. That is, the trap 470 may be considered at the core of the processing operations of the QIP system 400 since it holds the atomic-based qubits that are used to perform the quantum operations or simulations. At least a portion of the source 460 may be implemented separate from the chamber 450.

It is to be understood that the various components of the QIP system 400 described in FIG. 4 are described at a high-level for ease of understanding. Such components may include one or more sub-components, the details of which may be provided below as needed to better understand certain aspects of this disclosure.

Aspects of this disclosure may be implemented at least partially using the general controller 405, the automation and calibration controller 480, the optical and trap controller 420, and/or the imaging system 430.

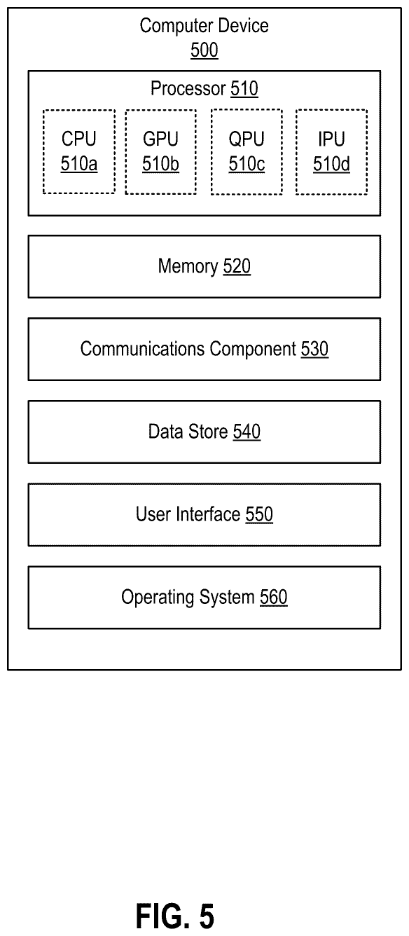

Referring now to FIG. 5 shown below, illustrated is an example of a computer system or device 500 in accordance with aspects of the disclosure. The computer device 500 can represent a single computing device, multiple computing devices, or a distributed computing system, for example. The computer device 500 may be configured as a quantum computer (e.g., a QIP system), a classical computer, or to perform a combination of quantum and classical computing functions, sometimes referred to as hybrid functions or operations. For example, the computer device 500 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 500 implemented as a QIP system capable of performing quantum computations and simulations is, for example, the QIP system 400 shown in FIG. 4.

The computer device 500 may include a processor 510 for carrying out processing functions associated with one or more of the features described herein. The processor 510 may include a single or multiple set of processors or multi-core processors. Moreover, the processor 510 may be implemented as an integrated processing system and/or a distributed processing system. The processor 510 may include one or more central processing units (CPUs) 510a, one or more graphics processing units (GPUs) 510b, one or more quantum processing units (QPUs) 510c, one or more intelligence processing units (IPUs) 510d (e.g., artificial intelligence or AI processors), or a combination of some or all those types of processors. In one aspect, the processor 510 may refer to a general processor of the computer device 500, which may also include additional processors 510 to perform more specific functions (e.g., including functions to control the operation of the computer device 500).

The computer device 500 may include a memory 520 for storing instructions executable by the processor 510 to carry out operations. The memory 520 may also store data for processing by the processor 510 and/or data resulting from processing by the processor 510. In an implementation, for example, the memory 520 may correspond to a computer-readable storage medium that stores code or instructions to perform one or more functions or operations. Just like the processor 510, the memory 520 may refer to a general memory of the computer device 500, which may also include additional memories 520 to store instructions and/or data for more specific functions.

It is to be understood that the processor 510 and the memory 520 may be used in connection with different operations including but not limited to computations, calculations, simulations, controls, calibrations, system management, and other operations of the computer device 500, including any methods or processes described herein.

Further, the computer device 500 may include a communications component 530 that provides for establishing and maintaining communications with one or more parties utilizing hardware, software, and services. The communications component 530 may also be used to carry communications between components on the computer device 500, as well as between the computer device 500 and external devices, such as devices located across a communications network and/or devices serially or locally connected to computer device 500. For example, the communications component 530 may include one or more buses, and may further include transmit chain components and receive chain components associated with a transmitter and receiver, respectively, operable for interfacing with external devices. The communications component 530 may be used to receive updated information for the operation or functionality of the computer device 500.

Additionally, the computer device 500 may include a data store 540, which can be any suitable combination of hardware and/or software, which provides for mass storage of information, databases, and programs employed in connection with the operation of the computer device 500 and/or any methods or processes described herein. For example, the data store 540 may be a data repository for operating system 560 (e.g., classical OS, or quantum OS, or both). In one implementation, the data store 540 may include the memory 520. In an implementation, the processor 510 may execute the operating system 560 and/or applications or programs, and the memory 520 or the data store 540 may store them.

The computer device 500 may also include a user interface component 550 configured to receive inputs from a user of the computer device 500 and further configured to generate outputs for presentation to the user or to provide to a different system (directly or indirectly). The user interface component 550 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 550 may include one or more output devices, including but not limited to a display, a speaker, a haptic feedback mechanism, a printer, any other mechanism capable of presenting an output to a user, or any combination thereof. In an implementation, the user interface component 550 may transmit and/or receive messages corresponding to the operation of the operating system 560. When the computer device 500 is implemented as part of a cloud-based infrastructure solution, the user interface component 550 may be used to allow a user of the cloud-based infrastructure solution to remotely interact with the computer device 500.

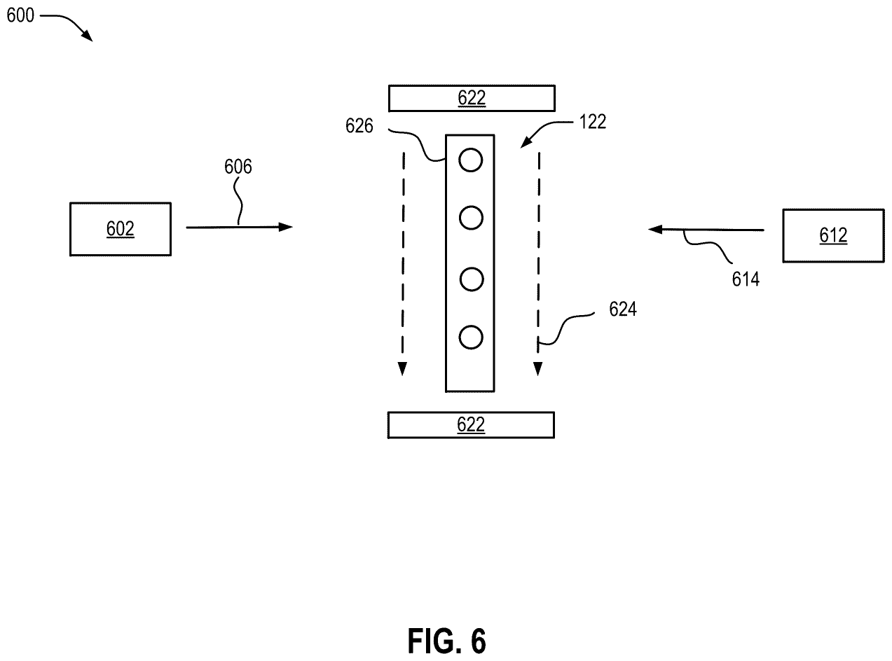

FIG. 6 illustrates an example of a control system 600 configured to control the ion chain 122 according to aspects of the present disclosure. The control system 600 may be an example configuration of a QIP system, such as the QIP system 400. The control system 600 may include the hardware associated with controlling the trapped ions in a QIP system.

In some aspects, the control system 600 may include first light source 602 configured to emit a global optical beam 606 toward the ion chain 122. The control system 600 may include a second light source 612 configured to emit individual Raman beams toward the ion chain 122. The control system 600 may include a magnetic system 622 configured to apply a magnetic field 624 across the ion chain 122. The control system 600 may include a biasing system 626 configured to apply one or more of a direct current (DC) and/or a radio frequency (RF) voltage bias on the ion chain 122. The biasing system 626 may include one or more electrodes configured to apply DC and/or the RF electric fields. In some aspects, the biasing system 626 may trap one or more ions in the ion chain 122.

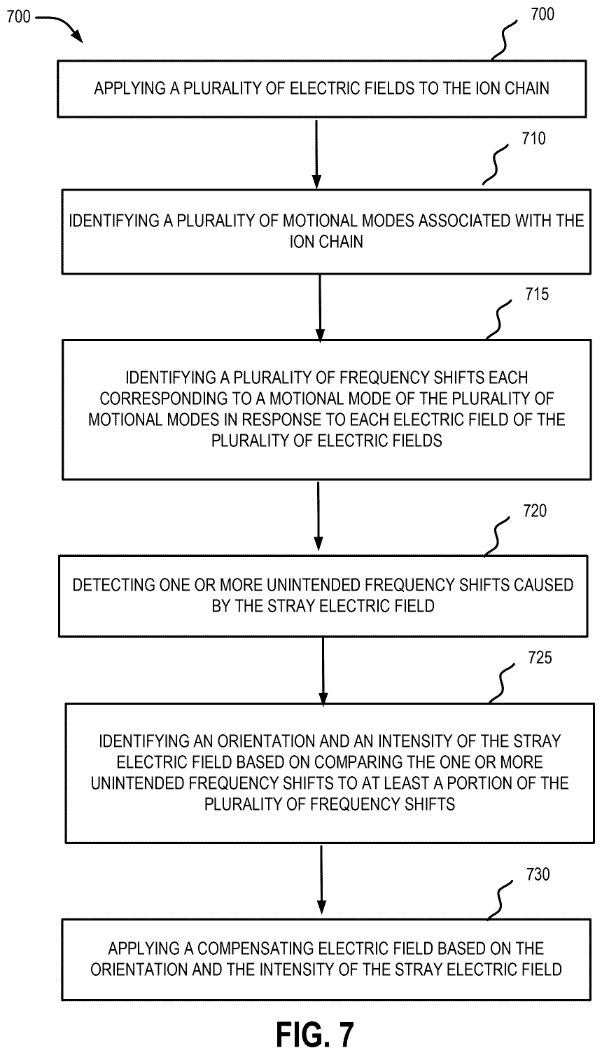

FIG. 7 illustrates an example of a method 700 for mitigating stray electric field using a saturation beam according to aspects of the present disclosure. The method 700 may be performed by one or more of the QIP system 400, the computer device 500, the control system 600, and/or one or more subcomponents of the QIP system 400, the computer device 500, or the control system 600.

At 705, the method 700 may apply a plurality of electric fields to the ion chain. For example, one or more of the one or more electrodes 110 and/or the biasing system 626 may apply a plurality of electric fields to the ion chain.

At 710, the method 700 may select a plurality of motional modes associated with the ion chain. For example, one or more of the optical and trap controller 420, the algorithm component 410, and/or the processor 510 may select a plurality of motional modes associated with the ion chain.

At 715, the method 700 may identify a plurality of frequency shifts each corresponding to a motional mode of the plurality of motional modes in response to each electric field of the plurality of electric fields. For example, one or more of the optical and trap controller 420, the algorithm component 410, and/or the processor 510 may identify a plurality of frequency shifts each corresponding to a motional mode of the plurality of motional modes in response to each electric field of the plurality of electric fields.

At 720, the method 700 may detect one or more unintended frequency shifts caused by the stray electric field. For example, one or more of the magnetic system 622, the biasing system 614, optical and trap controller 420, the algorithm component 410, and/or the processor 510 may detect one or more unintended frequency shifts caused by the stray electric field.

At 725, the method 700 may identify an orientation and an intensity of the stray electric field based on comparing the one or more unintended frequency shifts to at least a portion of the plurality of frequency shifts. For example, one or more of the optical and trap controller 420, the algorithm component 410, and/or the processor 510 may identify an orientation and an intensity of the stray electric field based on comparing the one or more unintended frequency shifts to at least a portion of the plurality of frequency shifts.

At 730, the method 700 may apply a compensating electric field based on the orientation and the intensity of the stray electric field. For example, one or more of the one or more electrodes 110 and/or the biasing system 626 may apply a compensating electric field based on the orientation and the intensity of the stray electric field.

E_{X} ample QIP systems that may implement aspects of the present disclosure are shown in FIGS. 4-6 and 8. For example, a QIP system may implement the methods described above to compensate for stray electric field associated with the ion trap of the QIP system. The QIP system may compensate for the stray electric field before or during the operation of the QIP system.

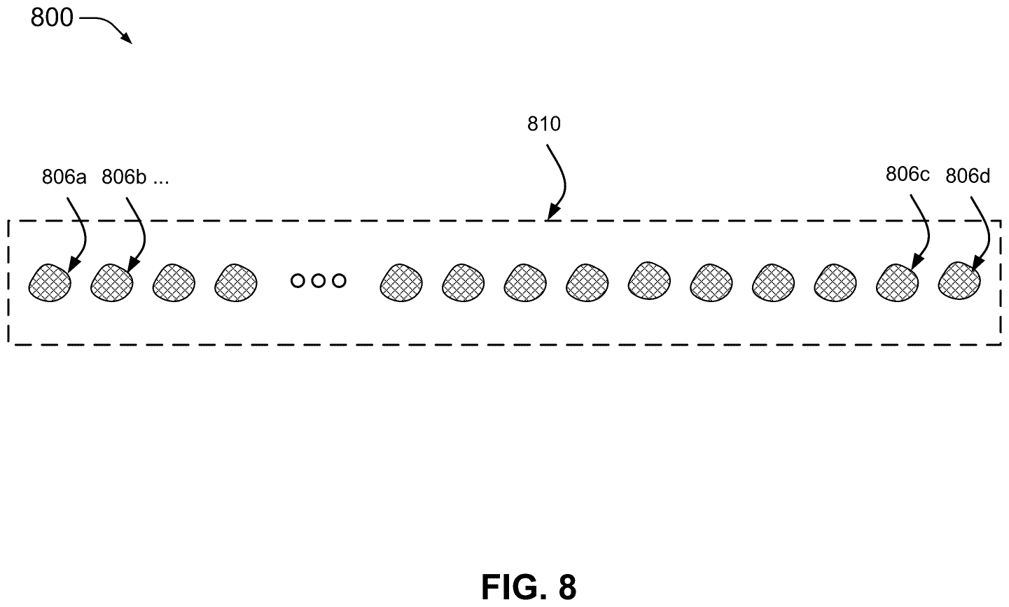

FIG. 8 shown below illustrates a diagram 800 with multiple atomic ions 806 (e.g., atomic ions 806a, 806b, . . . , 806c, and 806d) trapped in a linear crystal or chain 810 using a trap (the trap can be inside a vacuum chamber as shown in FIG. 9). The trap may be referred to as an ion trap. The ion trap shown may be built or fabricated on a semiconductor substrate, a dielectric substrate, or a glass die or wafer (also referred to as a glass substrate). The atomic ions 806 may be provided to the trap as atomic species for ionization and confinement into the chain 810.

In the example shown in FIG. 8, the trap includes electrodes for trapping or confining multiple atomic ions into the chain 810 that are laser-cooled to be nearly at rest. The number of atomic ions (N) trapped can be configurable and more or fewer atomic ions may be trapped. The atomic ions can be Ytterbium ions (e.g., 171Yb+ ions), for example. The atomic ions are illuminated with laser (optical) radiation tuned to a resonance in 171Yb+ and the fluorescence of the atomic ions is imaged onto a camera or some other type of detection device. In this example, atomic ions may be separated by about 5 microns (μm) from each other, although the separation may be smaller or larger than 5 μm. The separation of the atomic ions is determined by a balance between the external confinement force and Coulomb repulsion and does not need to be uniform. Moreover, in addition to atomic Ytterbium ions, neutral atoms, Rydberg atoms, different atomic ions or different species of atomic ions may also be used (such as one or more isotopes of barium, for example). The trap may be a linear RF Paul trap, but other types of confinement may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

In some aspects of the present disclosure, the chain 810 may be the ion chain 122 of the surface trap 120.

Aspects of the present disclosure may include a method and/or a system for applying a plurality of electric fields to the ion chain, selecting a plurality of motional modes associated with the ion chain, identifying a plurality of frequency shifts each corresponding to a motional mode of the plurality of motional modes in response to each electric field of the plurality of electric fields, detecting one or more unintended frequency shifts caused by the stray electric field, identifying an orientation and an intensity of the stray electric field based on comparing the one or more unintended frequency shifts to at least a portion of the plurality of frequency shifts, and applying a compensating electric field based on the orientation and the intensity of the stray electric field.

Aspects of the present disclosure include the method and/or system above, wherein applying plurality of electric fields comprises applying a first electric field in a first direction along the ion chain and a second electric field in a second direction perpendicular to the surface trap.

Aspects of the present disclosure include any of the methods and/or systems above, wherein the plurality of motional modes comprises a highest motional mode of a plurality of available motional modes associated with the ion chain, a middle motional mode of the plurality of available motional modes, and one of three lower motional modes of the plurality of available motional modes.

Aspects of the present disclosure include any of the methods and/or systems above, wherein identifying the plurality of frequency shifts comprises identifying the plurality of frequency shifts each corresponding to a motional mode of the plurality of motional modes in response to a change in an electric of the plurality of electric fields.

Aspects of the present disclosure include any of the methods and/or systems above, wherein the electric field is in a direction along the ion chain or perpendicular to the ion chain.

Aspects of the present disclosure include any of the methods and/or systems above, wherein the compensating electric field has a compensating orientation opposite of the orientation of the stray electric field and a compensating intensity identical to the intensity of the stray electric field.

Aspects of the present disclosure include any of the methods and/or systems above. The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of compensating for a stray electric field for an ion chain on a surface trap, comprising:
applying a plurality of electric fields to the ion chain;
identifying a plurality of motional modes associated with the ion chain;
identifying a plurality of frequency shifts each corresponding to a motional mode of the plurality of motional modes in response to each electric field of the plurality of electric fields;
detecting one or more unintended frequency shifts caused by the stray electric field;
identifying an orientation and an intensity of the stray electric field based on comparing the one or more unintended frequency shifts to at least a portion of the plurality of frequency shifts; and
applying a compensating electric field based on the orientation and the intensity of the stray electric field.

2. The method of claim 1, wherein applying plurality of electric fields comprises applying a first electric field in a first direction along the ion chain and a second electric field in a second direction perpendicular to the surface trap.

3. The method of claim 1, wherein the plurality of motional modes comprises a highest motional mode of a plurality of available motional modes associated with the ion chain, a middle motional mode of the plurality of available motional modes, and one of three lower motional modes of the plurality of available motional modes.

4. The method of claim 1, wherein identifying the plurality of frequency shifts comprises identifying the plurality of frequency shifts each corresponding to a motional mode of the plurality of motional modes in response to a change in an electric field of the plurality of electric fields.

5. The method of claim 4, wherein the electric field is in a direction along the ion chain or perpendicular to the ion chain.

6. The method of claim 1, wherein the compensating electric field has a compensating orientation opposite of the orientation of the stray electric field and a compensating intensity identical to the intensity of the stray electric field.

7. A non-transitory computer readable medium having instructions stored therein that, when executed by a processor of quantum information processing (QIP) system, cause the processor to:
apply a plurality of electric fields to an ion chain on a surface trap;
identify a plurality of motional modes associated with the ion chain;
identify a plurality of frequency shifts each corresponding to a motional mode of the plurality of motional modes in response to each electric field of the plurality of electric fields;
detect one or more unintended frequency shifts caused by a stray electric field;
identify an orientation and an intensity of the stray electric field based on comparing the one or more unintended frequency shifts to at least a portion of the plurality of frequency shifts; and
apply a compensating electric field based on the orientation and the intensity of the stray electric field.

8. The non-transitory computer readable medium of claim 7, wherein the instructions for applying plurality of electric fields comprises instructions for applying a first electric field in a first direction along the ion chain and a second electric field in a second direction perpendicular to the surface trap.

9. The non-transitory computer readable medium of claim 7, wherein the plurality of motional modes comprises a highest motional mode of a plurality of available motional modes associated with the ion chain, a middle motional mode of the plurality of available motional modes, and one of three lower motional modes of the plurality of available motional modes.

10. The non-transitory computer readable medium of claim 7, wherein the instructions for identifying the plurality of frequency shifts comprises instructions for identifying the plurality of frequency shifts each corresponding to a motional mode of the plurality of motional modes in response to a change in an electric field of the plurality of electric fields.

11. The non-transitory computer readable medium of claim 7, wherein the electric field is in a direction along the ion chain or perpendicular to the ion chain.

12. The non-transitory computer readable medium of claim 7, wherein the compensating electric field has a compensating orientation opposite of the orientation of the stray electric field and a compensating intensity identical to the intensity of the stray electric field.

13. A quantum information processing (QIP) system, comprising:
one or more electrodes configured to:
apply a plurality of electric fields to an ion chain on a surface trap, and
apply a compensating electric field based on an orientation and an intensity of a stray electric field;
a magnetic system configured to detect one or more unintended frequency shifts caused by the stray electric field; and
one or more processors configured to:
identify a plurality of motional modes associated with the ion chain,
identify a plurality of frequency shifts each corresponding to a motional mode of the plurality of motional modes in response to each electric field of the plurality of electric fields, and
identify the orientation and the intensity of the stray electric field based on comparing the one or more unintended frequency shifts to at least a portion of the plurality of frequency shifts.

14. The QIP system of claim 13, wherein the one or more electrodes are further configured to apply a first electric field in a first direction along the ion chain and a second electric field in a second direction perpendicular to the surface trap.

15. The QIP system of claim 13, wherein the plurality of motional modes comprises a highest motional mode of a plurality of available motional modes associated with the ion chain, a middle motional mode of the plurality of available motional modes, and one of three lower motional modes of the plurality of available motional modes.

16. The QIP system of claim 13, wherein the one or more processors are further configured to identify the plurality of frequency shifts each corresponding to a motional mode of the plurality of motional modes in response to a change in an electric of the plurality of electric fields.

17. The QIP system of claim 16, wherein the electric field is in a direction along the ion chain or perpendicular to the ion chain.

18. The QIP system of claim 13, wherein the compensating electric field has a compensating orientation opposite of the orientation of the stray electric field and a compensating intensity identical to the intensity of the stray electric field.
